(19) United States
(12) Patent Application Publication
(10) Pub. No.: US 2015/0095973 A1
(43) Pub. Date: Apr. 2, 2015

(54) CLOUD DATABASE LOCKDOWN

(71) Applicant: Oracle International Corporation, Redwood Shores, CA (US)

(72) Inventors: Christian Neumueller, Redwood Shores, CA (US); Mark Fallon, Redwood Shores, CA (US); Dom Lindars, Redwood Shores, CA (US); Joel R. Kallman, Powell, OH (US); Michael Hichwa, Bethesda, MD (US)

(21) Appl. No.: 14/485,616

(22) Filed: Sep. 12, 2014

Related U.S. Application Data
(60) Provisional application No. 61/883,884, filed on Sep. 27, 2013.

(51) Int. Cl. H04L 29/06

(52) U.S. Cl. CPC H04L 63/20; H04L 63/083
USPC 726/1

(57) ABSTRACT

Techniques are described herein for locking down a cloud database. In an embodiment, each respective database cloud service of a plurality of database cloud services is associated with a different respective database schema of a plurality of database schemas within a database. For each respective database cloud service of the plurality of database cloud services, the respective database cloud service is prevented from accessing the plurality of database schemas except for the respective database schema that is associated with the respective database cloud service.

### CROSS-REFERENCE TO RELATED APPLICATIONS; BENEFIT CLAIM

This application claims the benefit of Provisional Appln. No. 61/883,884, filed Sep. 27, 2013, the entire contents of which is hereby incorporated by reference as if fully set forth herein, under 35 U.S.C. §119(e). This application is related to U.S. Appln. No. ______ (Attorney Docket No. 50277-4146), filed ______, 2013, the entire contents of which is hereby incorporated by reference as if fully set forth herein and referred to herein as LOADING A DATABASE INTO THE CLOUD. This application is also related to U.S. Appln. No. ______ (Attorney Docket No. 50277-4148), filed ______, 2013, the entire contents of which is hereby incorporated by reference as if fully set forth herein and referred to herein as CLOUD DATABASE CONNECTION MULTIPLEXING.

### FIELD OF THE INVENTION

The present disclosure relates to cloud computing and, more specifically, to techniques for providing security for consumer data stored on a cloud platform.

### BACKGROUND

Cloud computing involves the use of computing resources (hardware and software) that are delivered as a service over a network (typically the Internet). To reduce the costs of providing the service to a plurality of consumers, cloud computing systems may use some form of resource sharing. For example, in some cloud computing models, consumers may share database resources.

One approach to the shared database model involves providing each consumer with their own database instance in a corresponding virtual machine. This approach allows users to share a virtual machine to access database resources. However, the scalability of this approach may be limited, as the number of virtual machines that the service provides may be restricted by the number of underlying processors of the physical machine. Furthermore, each virtual machine involves the overhead of the entire solution stack, from the operating system to the database instance.

Although sharing database resources reduces costs, it also presents many security implications. Due to the multi-tenant nature of cloud systems, there is a risk that one consumer may gain access to and/or corrupt another consumer's data if the cloud environment is improperly secured. Such a risk is a high-priority concern for many consumers, especially for those in highly-regulated domains that have sensitive customer data.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

Various embodiments are illustrated by way of example, and not by way of limitation, in the figures of the accompanying drawings and in which like reference numerals refer to similar elements and in which:

FIG. 1 is a block diagram depicting an example system that may be used to provide database cloud services to consumers, according to an embodiment;

FIG. 2 is a block diagram depicting an example schema isolation model, according to an embodiment

FIG. 3 is a flowchart depicting an example process for pre-provisioning and assigning database schemas, according to an embodiment;

FIG. 4 is a flowchart depicting an example lockdown process for maintaining schema isolation within a database system, according to an embodiment;

FIG. 5 is a block diagram depicting a computer system upon which an embodiment may be implemented.

### DETAILED DESCRIPTION

Techniques are described herein for providing security for database cloud services. In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

A database schema is a way to logically group database objects within a database. One purpose of a database schema is to provide namespace separation for database objects that belong to different database users. This allows the database system to differentiate between database objects with identical identifiers. When a query is received from a database user, by default, the query is executed against database objects that belong to the user's database schema.

In some circumstances, a database system may allow one database user to access the objects in another user's database schema. For example, some database systems allow grants of system privileges, roles, and/or object privileges. In such database systems, one user (the granting user) may explicitly grant another user or the public (i.e., all users of the database system) access privileges to one or more objects in the granting user's database schema. In addition or alternatively, such systems may grant a user system privileges, allowing the user to perform an action on any schema object of a particular type. For instance, one system privilege may allow a user to create tables and delete the rows of any table in a database.

According to techniques described herein, each consumer that registers for a database cloud service is assigned a database schema within a database system. The database system is configured to prevent privilege grants and other paths that allow one database cloud service to access and/or detect the existence of another database cloud service's database schema. Thus, rather than a way to provide namespace separation, the database schemas within a database system may be used to provide consumers with a virtual private database that cannot be accessed or detected by other consumers, even when those consumers are sharing the same database instance.

### Database Cloud Service

A “database cloud service” is a service that provides access to a database system running on a cloud platform. In order to use the service, a consumer creates an account through a registration or subscription process established by the service provider. The account may correspond to an individual user or a set of users, depending on the particular implementation. For example, an account may correspond to a particular organization that has a plurality of users that share access to a particular database cloud service. Each account may also be associated with one or more database cloud services, where the data loaded into each individual database cloud service is logically separated from data in other database cloud services within the cloud platform.

A “cloud database” as used herein refers to a database system running on a cloud platform and/or a physical database in the cloud platform.

A “consumer” of a database cloud service is a set of one or more users associated with an individual account. When there are multiple users associated with an account, the users may have equal access privileges or the access privileges may vary from user to user or for different groups of users. For example, each account may have a particular user that acts as an account administrator. Certain account privileges may be reserved solely for the administrator. Example privileges that may be reserved for the account administrator include, without limitation, adding, defining, and deleting users for the corresponding database cloud service; paying fees, if any, associated with the account; and monitoring, configuring, and selecting administrative parameters for the respective account.

The cloud computing model of the database cloud service may vary from implementation to implementation. In an embodiment, the database cloud service may have some characteristics of a Platform-as-a-Service (PaaS) rather than a Database-as-a-Service (DBaaS). For example, the database cloud service may give the user programmatic access to an underlying database within the cloud platform through a structured query language (SQL) or a procedural language, such as a procedural language extension to SQL (e.g., PL/SQL). The user's programs may be executed from inside the cloud platform and/or through web services. As another example, the database cloud service may be a fully managed service, without requiring the user to perform maintenance operations on the underlying database or system software within the cloud. In addition or alternatively, the database cloud service may manage the configuration parameters for a database instance rather than the user and may allow multiple tenants on a single database instance. In other embodiments, the database cloud service may have one or more characteristics of a DBaaS. For example, in some embodiments the user may be permitted to configure the database system settings In other embodiments, the database cloud service may be offered as, or in conjunction with, a Software-as-a-Service (SaaS), Middleware-as-a-Service (MWaaS), Infrastructure-as-a-Service (IaaS), or some other cloud computing solution.

The architecture of the cloud platform, including the hardware and software resources used to provide the database cloud services, may vary from implementation to implementation and may be updated by the service provider over time. In one embodiment, the cloud platform may provide the consumer with access to a distributed database system, where the consumer's database is distributed across a plurality of physical locations. In another embodiment, the cloud platform may provide the consumer with access to a non-distributed database that resides on a single node.

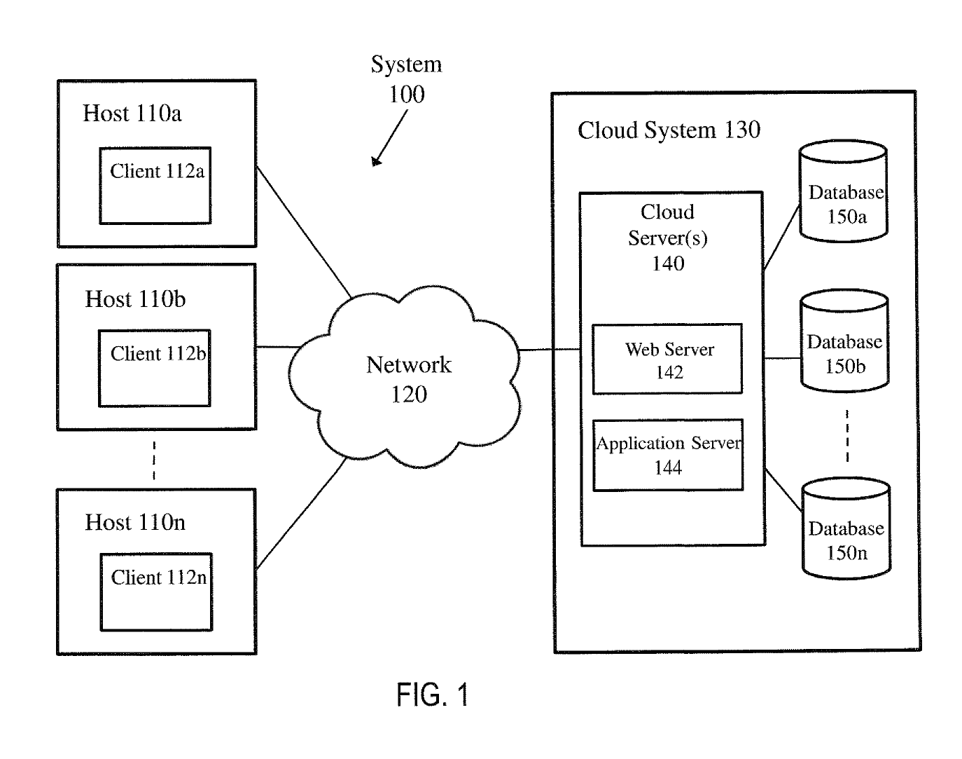

FIG. 1 is a block diagram depicting an example system that may be used to provide database cloud services to consumers, according to an embodiment. System 100 includes one or more network hosts 110a to 110n, which are connected to network 120. Network hosts 110a to 110n may be any computing device capable of sending and receiving data over network 120. Examples include, without limitation, devices that implement the Internet Protocol Suite (IP hosts), such as desktop computers, laptops, tablets, and mobile phones. Network hosts 110a to 110n include clients 112a to 112n, which act as interfaces between the consumers and their respective database cloud services. Each of clients 112a to 112n may comprise a set of one or more software applications which may be used by a consumer to register for a database cloud service and/or access the service. For example, clients 112a to 112n may include, without limitation a web browser, an integrated development environment (IDE) such as SQL Developer, and other applications that provide an interface for interacting with a web server. Clients 112a to 112n may comprise a graphical user interface (GUI) for receiving input and displaying output to consumers.

Network 120 may comprise one or more private and public computer networks (e.g., the Internet) that communicate according to a set of communication protocols (e.g., protocols included in the Internet Protocol Suite). In an embodiment, clients 112a to 112n communicate with cloud system 130 through a web application programming interface (API), such as through web services that follow the architectural principals of representational state transfer (RESTful web services). RESTful web service may include the following characteristics: the web services explicitly use methods of the Hypertext Transfer Protocol (HTTP), the web services are accessible through URIs, and the services are stateless. Accordingly, clients 112a to 112n may access their respective services by sending HTTP and HTTP Secure (HTTPS) requests to cloud system 130. The term “HTTP request” as used herein may refer, without limitation, to both HTTP and HTTPS requests.

Cloud system 130 includes cloud server 140 and one or more database systems 150a to 150n. Cloud server 140 may act as a central hub to receive and service requests from various consumers. Cloud server 140 may comprise web server 142 and application server 144. Web server 142 performs access control, such as verifying a consumer's authentication credentials and establishing secure connections for the consumer. Web server may store consumer requests in an administrative database for subsequent processing by application server 144. The administrative database (not shown) may be provisioned into one of database systems 150a to 150n. Application server 144 may include an event handler that polls the administrative database for consumer requests that have not yet been processed. Application server 144 may route and process the requests according to techniques described in CLOUD DATABASE CONNECTION MULTIPLEXING. Although only one cloud server 140 is depicted, in other implementations, cloud system 130 may include multiple cloud servers. For example, one cloud server may service a plurality of databases physically located in one region while a second cloud server may be used to service a plurality of databases physically located in a different region. In addition, each cloud server may include multiple web servers, application servers, and/or FTP servers. Each Cloud and/or application server is capable of routing to multiple database systems, establishing a one-to-many relationship between the server that receives consumer requests and the database systems that store consumer data.

Databases systems 150a to 150n manage and store organized collections of data for a plurality of consumers. Database systems 150a to 150n collectively or a subset of one or more of databases 150a to 150n may be referred to herein as a “cloud database”. Each of databases systems 150a to 150n may comprise a database server that provides application server 144 (which may comprise a database client) with access to an underlying database. Each of database systems 150a to 150n may correspond to a different database instance comprising a set of memory structures and/or processes used by a database management system (DBMS) to manage and access files stored in an underlying database. For example, a database instance may include, without limitation, data caches for storing memory retrieved from the database, log writing processes for writing data to a log in the database, and/or input/output (I/O) processes for interacting with database files on disk. Cloud server 140 may be communicatively coupled to database systems 150a to 150n via one or more data communication networks, such as a Local Area Network (LAN), or via a direct physical connection.

### Schema Isolation

When a consumer registers for a database cloud service, the consumer is assigned a database schema within one of databases 150a to 150n. The database schema that is allocated for a particular database cloud service may logically represent a storage location within a database where a consumer may store data. The database schema defines and/or describes a set of one or more database objects within a database and namespace for those database objects. A namespace is a domain of objects in which the name of an object is unique among the names of other objects of that type and/or other types within the namespace. For example, within a schema, the label or name of a table is unique among the name of tables and views within a schema. However, two tables in two different schemas may have the same name.

Consumers of a particular database cloud service are associated with a schema. By default, the names of database objects referenced in queries issued by a user associated with a schema are resolved to database objects within the schema. For example, a schema A and schema B both include a table with the label EMPLOYEE. Both tables are in the same database. A consumer associated with schema A issues a query referencing a table by the name EMPLOYEE. During compilation of the query, the name EMPLOYEE is resolved to the so named table within schema A. A database schema may comprise, without limitation, one or more dedicated tablespaces, where the consumer may store tables, indexes, sequences, views, and other database objects. A tablespace, as used herein, refers to a defined and named set of files or portion of a file that holds database data.

Each of database systems 150a to 150n may comprise a plurality of database schemas allocated to different database cloud services/consumers. The same database instance may be used to manage the plurality of database schemas within an individual database. For instance, different database cloud services may share system memory, server processes, and/or background processes running on a single database host. Example system memory that may be shared by different database cloud services may include, without limitation, database buffer caches, redo log buffers, and data dictionary caches. Example background processes (or threads) that may be shared by different database cloud services may include, without limitation, input/output (I/O) processes for reading and writing data to the database, log writing processes for writing log data to a log file, checkpoint processes for maintaining logical time for the database, and monitoring processes for monitoring system performance. Access to a database schema is isolated to a single database cloud service to prevent one consumer from gaining unauthorized access to another consumer's data. Thus, each database schema acts as a virtual private database for the consumer to which it is assigned.

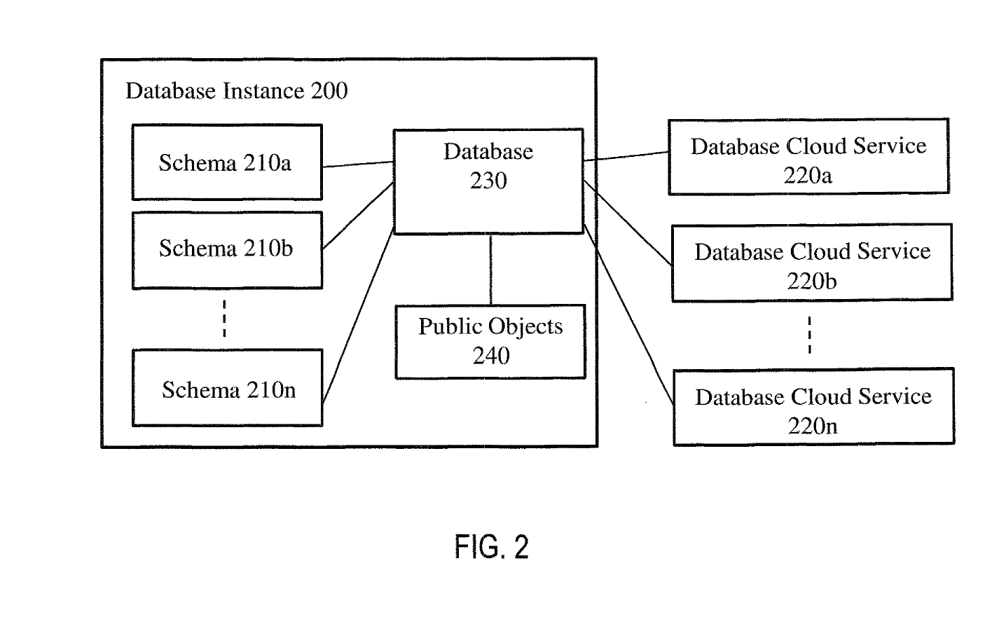

FIG. 2 is a block diagram depicting an example schema isolation model, according to an embodiment. Database 230 comprises a plurality of database schemas 210a to 210n. Database schemas 210a to 210n are assigned to database cloud services 220a to 220n, respectively. Each of database cloud services 220a to 220n may connect to database instance 200 to access their respective database schemas. In an embodiment, database 230 is configured to prevent any database cloud service from accessing or detecting the existence of database schemas that belong to other database cloud services. Thus, database cloud service 220a may add, delete, modify, read, and otherwise access objects in database schema 210a. However, database cloud service 220a is prevented from doing so with respect to database schemas 210b to 210n. In addition, database cloud service 220a may be prevented from identifying how many and what other schemas (schemas 210b to 210n) exist in the same database. Accordingly, each database schema remains unidentifiable, inaccessible, and anonymous with respect to unassociated database cloud services. To prevent cross-schema accesses, database 230 may be configured according to the pre-provisioning and post-provisioning lockdown processes described below.

Database 230 further comprises public objects 240, which may be accessed by database cloud services 210a to 210n when connected to database instance 200. Public objects 240 may comprise any object that does not compromise the security of database schemas 210a to 210n. Public objects 240 may include, without limitation, one or more database supplied packages, tables, and views. For example, public objects 240 may include a utility package for generating extensible markup language (XML) objects within a database schema. In addition or alternatively, public objects 240 may comprise a data dictionary comprising metadata that defines objects within database 230. Even though the data dictionary may be made public, database 230 restricts database cloud services 210a to 210n to accessing views of the data dictionary that do not include metadata for objects within database schemas that belong to other database cloud services. Thus, a consumer may not detect the presence of another consumer's data within the database.

### Pre-Provisioning Lockdown Process

Before database schemas are assigned to consumers, a script may be run within the database to configure available privileges in accordance with a lockdown policy. The lockdown policy may comprise a list of objects (a “whitelist”) that may remain publicly accessible within the database without comprising the security of a consumer's database schema. Objects that are not included on the whitelist have their public privileges removed.

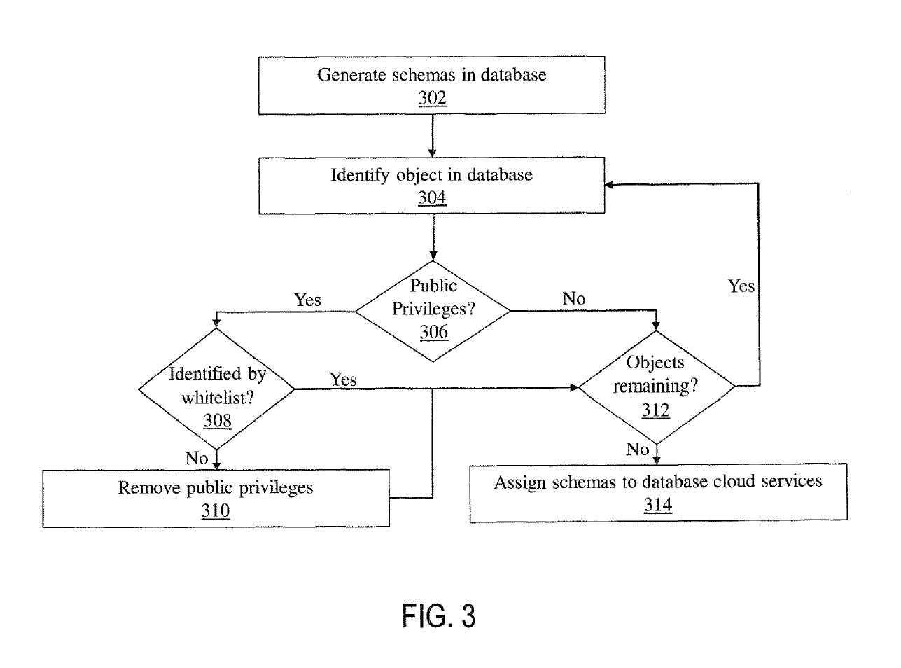

FIG. 3 is a flowchart depicting an example process for pre-provisioning and assigning database schemas, according to an embodiment. In step 302, a plurality of database schemas are generated within a database. The number of database schemas that are generated within an individual database may vary from implementation to implementation. For example, the number of database cloud services that a database may support may be based, in part, on the size of the database and the storage space allocated to each of the database schemas.

In step 304, the lockdown script identifies an object in the database. The object may include, without limitation, a utility package, table, view, index, stored procedure, cache group, or other database object. In step 306, the lockdown script determines whether the object has been granted public privileges. If the object has been granted public privileges, then in step 308, the lockdown script determines whether the object is included or otherwise identified by 312 the whitelist. If the object is not included on the whitelist, then, in step 310, the public privileges are removed. Removing the public privileges may comprise shifting the privileges to an internal database schema that is not accessible to any database cloud service. In step 312, the lockdown script determines whether there are any objects remaining. If so, then the process returns to step 304. Otherwise, the process continues to step 314.

In step 314, the database schemas are assigned to different database cloud services as consumers register for the services. For example, when a consumer initially signs up for a database cloud service, cloud system 130 may select a database schema within database 230 and assign the database schema to the consumer. Techniques for assigning database schemas are described in further detail in CLOUD DATABASE CONNECTION MULTIPLEXING.

### Post-Provisioning Lockdown Process

Once a database schema has been assigned to a consumer, the database system prevents grants and other database operations that may allow one database cloud service to access or otherwise detect a database schema that belongs to another database cloud service. To maintain schema isolation, database systems 150a to 150n may comprise a Data Definition Language (DDL) trigger that activates a lockdown process whenever a DDL command is received.

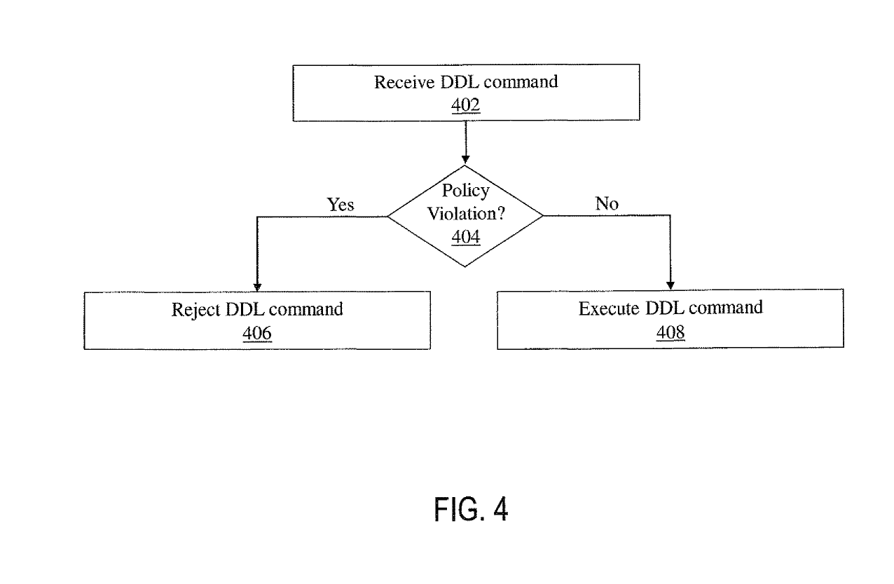

FIG. 4 is a flowchart depicting an example lockdown process for maintaining schema isolation within a database system, according to an embodiment. In step 402, a DDL command is received for a target database cloud service.

In step 404, the DDL command is analyzed to determine whether it violates a lockdown policy maintained by the database system. A DDL commands may violate the lockdown policy if it enables another database cloud service to access or detect the database schema of the target database cloud service. Example violations may include, without limitation, DDL commands including GRANT statements that grant privileges to another database cloud service or to public. A DDL command may also violate the lockdown policy if the DDL command enables the target database cloud service to access or retrieve identification data for the database schema of another database cloud service. Example violations may include calls to private objects (i.e., those objects not included in the whitelist) or attempts to gain system privileges.

If the DDL command violates the lockdown policy, then, in step 406, the DDL command is rejected. During this step, the lockdown process may issue an error message to the consumer to indicate that the database command violated the lockdown policy and could not be processed. In addition or alternatively, the lockdown process may generate an alert to notify an administrator of cloud system 130. If the lockdown process determines that the DDL command does not violate the lockdown policy, then, in step 408, the database system executes the DDL command.

### Lockdown Monitoring

Database systems 150a to 150n may comprise processes that periodically monitor the databases to ensure that the privileges associated with each database cloud service conforms to a lockdown policy. For example, database 230 may be queried by a monitoring process to determine which privileges are associated with database cloud service 210a to 210n. If the privileges deviate from those specified in a lockdown policy, then a flag may be generated to alert an administrator of cloud system 130 and/or the privileges of the target database cloud service may be reset to those that were initially assigned. In example embodiment, a flag may be generated if a monitoring process detects that database cloud service 210a holds a privilege to an object belonging to another service's database schema or holds a system privilege that grants the database cloud service the right to perform an action on any object of a particular type. In another embodiment, a flag may be generated if the privileges of the database cloud service do not match the set of privileges that were initially assigned to the database cloud service upon registration.

### Schema-Based Resource Balancing

In an embodiment, the database system includes a resource manager to distribute machine resources among database cloud services. This may prevent any consumer/database cloud service from significantly impacting the performance of other database cloud services.

In an embodiment, all database cloud service operations are initially placed in a group with a highest priority to access shared resources (e.g., Central Processing Unit (CPU) processes, I/O resources, etc.). If a particular database cloud service exceeds a threshold resource usage associated with this initial group, the database cloud service may be moved to a lower priority group, with a higher resource usage threshold, but a lower priority to access shared resources. Database cloud services that belong to higher-priority groups are granted access to shared resources ahead of database cloud services in lower priority groups. If the database cloud service exceeds the new threshold, the database cloud service may further be pushed to a lower priority group with a higher resource usage threshold. This process may continue a threshold amount of times. Once a database cloud service has been pushed to a lower priority group more than the threshold, a user process associated with the database cloud service may be terminated.

Determining whether a database cloud service exceeds a threshold resource usage may vary from implementation to implementation. For example, the determination may be made based on how much CPU time and/or I/O bandwidth a database cloud service consumes. If the CPU time and/or I/O bandwidth consumer by a database cloud service exceeds a threshold, then the database cloud service may be shifted to a lower-priority group or a user process associated with the database cloud service may be terminated.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

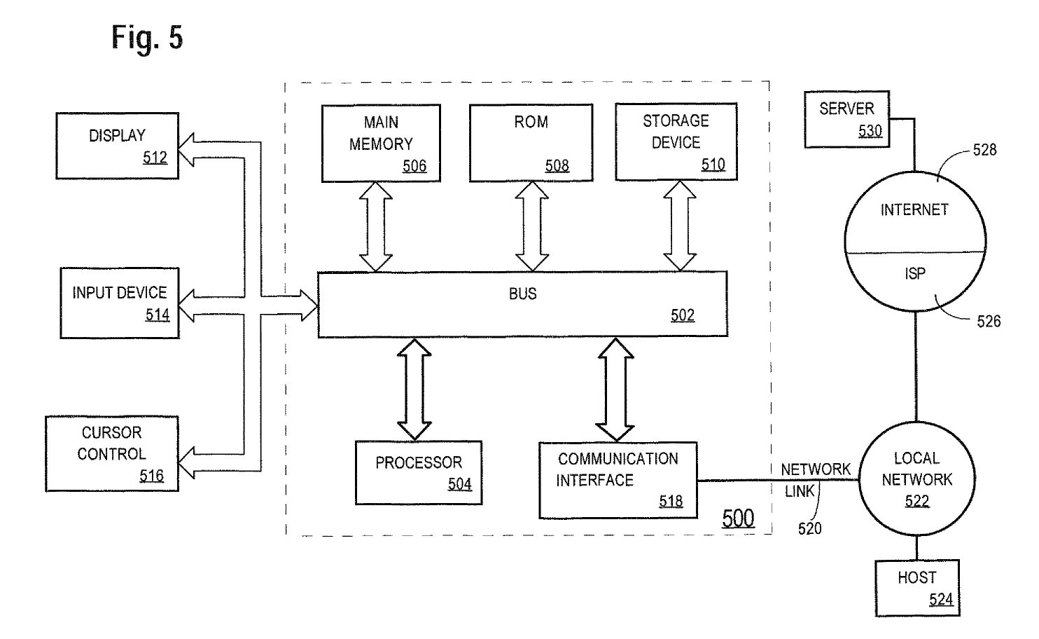

For example, FIG. 5 is a block diagram that illustrates a computer system 500 upon which an embodiment of the invention may be implemented. Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk, optical disk, or solid-state drive is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 510. Volatile media includes dynamic memory, such as main memory 506. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid-state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

### Extensions and Alternatives

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method for providing secure database cloud services to a plurality of consumers, the method comprising:
associating each respective database cloud service of a plurality of database cloud services with a different respective database schema of a plurality of database schemas within a database;
for each respective database cloud service of the plurality of database cloud services, preventing the respective database cloud service from accessing the plurality of database schemas except for the respective database schema that is associated with the respective database cloud service;
wherein the method is performed by one or more computing devices.

2. The method of claim 1, wherein the plurality of database cloud services share a database instance for accessing each respective database schema of said plurality of database schemas.

3. The method of claim 2, further comprising:
preventing each database cloud service of the plurality of database cloud services from consuming more than a threshold amount of resources associated with the database instance.

4. The method of claim 1, wherein preventing the respective database cloud service from accessing the plurality of database schemas except for the respective database schema that is associated with the respective database cloud service comprises:
preventing each respective database cloud service of the plurality of database cloud services from granting, to another database cloud service of the plurality of database cloud services, privileges with respect to the plurality of database schemas.

5. The method of claim 1, wherein preventing the respective database cloud service from accessing the plurality of database schemas except for the respective database schema that is associated with the respective database cloud service comprises:
receiving a data definition language (DDL) command from a particular database cloud service;
in response to receiving the DDL command, analyzing the DDL command to determine whether the DDL command compromises a security associated with at least one database schema of the plurality of database schemas;
in response to determining that the DDL command compromises the security associated with the at least one database schema of the plurality of database schemas, rejecting the DDL command.

6. The method of claim 1, further comprising:
before associating each respective database cloud service of a plurality of database cloud services with a different respective database schema of a plurality of database schemas within a database:
searching the database for objects that are publicly accessible;
in response to identifying a particular object that is publicly accessible, determining whether the particular object is identified by a list of objects that may remain publicly accessible;
in response to determining that the particular object is not identified by the list, removing public privileges from the particular object.

7. The method of claim 1, further comprising:
monitoring the plurality of database cloud services to detect changes in privileges associated with the plurality of database cloud services;
in response to detecting a change in privileges associated with the plurality of database cloud services, generating an alert.

8. One or more non-transitory computer-readable media storing instructions, which, when executed by one or more processors, cause one or more computing devices to perform:
associating each respective database cloud service of a plurality of database cloud services with a different respective database schema of a plurality of database schemas within a database;
for each respective database cloud service of the plurality of database cloud services, preventing the respective database cloud service from accessing the plurality of database schemas except for the respective database schema that is associated with the respective database cloud service.

9. The non-transitory computer-readable media of claim 8, wherein the plurality of database cloud services share a database instance for accessing each respective database schema of said plurality of database schemas.

10. The non-transitory computer-readable media of claim 9, further comprising instructions, which, when executed by one or more processors, cause one or more computing devices to perform:
preventing each database cloud service of the plurality of database cloud services from consuming more than a threshold amount of resources associated with the database instance.

11. The non-transitory computer-readable media of claim 8, wherein instructions for preventing the respective database cloud service from accessing the plurality of database schemas except for the respective database schema that is associated with the respective database cloud service comprise instructions for:
preventing each respective database cloud service of the plurality of database cloud services from granting, to another database cloud service of the plurality of database cloud services, privileges with respect to the plurality of database schemas.

12. The non-transitory computer-readable media of claim 8, wherein instructions for preventing the respective database cloud service from accessing the plurality of database schemas except for the respective database schema that is associated with the respective database cloud service comprise instructions for:
receiving a data definition language (DDL) command from a particular database cloud service;
in response to receiving the DDL command, analyzing the DDL command to determine whether the DDL command compromises a security associated with at least one database schema of the plurality of database schemas;
in response to determining that the DDL command comprises the security associated with the at least one database schema of the plurality of database schemas, rejecting the DDL command.

13. The non-transitory computer-readable media of claim 8, further comprising instructions, which, when executed by one or more processors, cause one or more computing devices to perform:
before associating each respective database cloud service of a plurality of database cloud services with a different respective database schema of a plurality of database schemas within a database:
searching the database for objects that are publicly accessible;
in response to identifying a particular object that is publicly accessible, determining whether the particular object is identified by a list of objects that may remain publicly accessible;
in response to determining that the particular object is not identified by the list, removing public privileges from the particular object.

14. The non-transitory computer-readable media of claim 8, further comprising instructions, which, when executed by one or more processors, cause one or more computing devices to perform:
monitoring the plurality of database cloud services to detect changes in privileges associated with the plurality of database cloud services;
in response to detecting a change in privileges associated with the plurality of database cloud services, generating an alert.

15. A system for routing requests for database cloud services, the system comprising:
one or more processors;
one or more non-transitory computer-readable media storing instructions, which, when executed by the one or more processors, cause one or more computing devices to perform:
associating each respective database cloud service of a plurality of database cloud services with a different respective database schema of a plurality of database schemas within a database;
for each respective database cloud service of the plurality of database cloud services, preventing the respective database cloud service from accessing the plurality of database schemas except for the respective database schema that is associated with the respective database cloud service.

16. The system of claim 15, wherein the plurality of database cloud services share a database instance for accessing each respective database schema of said plurality of database schemas.

17. The system of claim 16, further comprising instructions, which, when executed by one or more processors, cause one or more computing devices to perform:
preventing each database cloud service of the plurality of database cloud services from consuming more than a threshold amount of resources associated with the database instance.

18. The system of claim 15, wherein instructions for preventing the respective database cloud service from accessing the plurality of database schemas except for the respective database schema that is associated with the respective database cloud service comprise instructions for:
preventing each respective database cloud service of the plurality of database cloud services from granting, to another database cloud service of the plurality of database cloud services, privileges with respect to the plurality of database schemas.

19. The system of claim 15, wherein instructions for preventing the respective database cloud service from accessing the plurality of database schemas except for the respective database schema that is associated with the respective database cloud service comprise instructions for:
receiving a data definition language (DDL) command from a particular database cloud service;
in response to receiving the DDL command, analyzing the DDL command to determine whether the DDL command compromises a security associated with at least one database schema of the plurality of database schemas;
in response to determining that the DDL command comprises the security associated with the at least one database schema of the plurality of database schemas, rejecting the DDL command.

20. The system of claim 15, further comprising instructions, which, when executed by one or more processors, cause one or more computing devices to perform:
before associating each respective database cloud service of a plurality of database cloud services with a different respective database schema of a plurality of database schemas within a database:
searching the database for objects that are publicly accessible;
in response to identifying a particular object that is publicly accessible, determining whether the particular object is identified by a list of objects that may remain publicly accessible;
in response to determining that the particular object is not identified by the list, removing public privileges from the particular object.

21. The system of claim 15, further comprising instructions, which, when executed by one or more processors, cause one or more computing devices to perform:
monitoring the plurality of database cloud services to detect changes in privileges associated with the plurality of database cloud services;
in response to detecting a change in privileges associated with the plurality of database cloud services, generating an alert.
